(19) United States
(12) Patent Application Publication
(10) Pub. No.: US 2024/0224338 A1
(43) Pub. Date: Jul. 4, 2024

(54) METHOD AND APPARATUS FOR TRANSRECEIVING SIGNAL, AND COMMUNICATION SYSTEM

(71) Applicant: FUJITSU LIMITED, Kawasaki-shi Kanagawa (JP)

(72) Inventors: Guorong LI, Beijing (CN); Meiyi JIA, Beijing (CN); Lei ZHANG, Beijing (CN); Xin WANG, Beijing (CN)

(73) Assignee: FUJITSU LIMITED, Kawasaki-shi Kanagawa (JP)

(21) Appl. No.: 18/430,057

(22) Filed: Feb. 1, 2024

Related U.S. Application Data
(63) Continuation of application No. PCT/CN2021/110680, filed on Aug. 4, 2021.

(51) Int. Cl. H04W 74/0833; H04W 8/22; H04W 72/02; H04W 72/0457; H04W 76/19; H04W 76/30

(52) U.S. Cl. CPC H04W 74/0833; H04W 8/22; H04W 72/02; H04W 72/0457; H04W 76/19; H04W 76/30

(57) ABSTRACT

Embodiments of this disclosure provide an apparatus for transceiving a signal, applicable to a reduced capability UE (Redcap UE), the apparatus including a first transceiving unit configured to enable: the Redcap UE to obtain configuration of a first initial downlink BWP, the first initial downlink BWP being an initial downlink BWP that is separately configured or defined for the Redcap UE; and the Redcap UE to receive a signal by using the first initial downlink BWP before random access is completed.

### CROSS-REFERENCE TO RELATED APPLICATION

This application is a continuation of International Application No. PCT/CN2021/110680, filed on Aug. 4, 2021, the entire contents of which are incorporated herein by reference.

### TECHNICAL FIELD

This disclosure relates to the field of communication technologies.

### BACKGROUND

In current 3GPP standards, a terminal equipment (such as a UE) performs the following operations in an initial network access procedure:
operation 1) obtaining a master information block (MIB) by searching for a cell defining PBCH/synchronization signal block (CD-SSB), so as to obtain configuration of a physical downlink control channel (PDCCH) scheduling system information block type 1 (SIB1) of the cell, the configuration including control resource set 0 (CORESET #0) configuration and search space 0 (SS #0) configuration;
operation 2) monitoring the PDCCH by the UE according to the configuration of CORESET #0/SS #0 to obtain SIB1, SIB1 containing such information as configuration of an initial DL BWP, configuration of an initial UL BWP, configuration of random access, and other common configurations of the cell;
operation 3) initiating a random access procedure by using relevant configuration of random access in the configuration of the initial UL BWP, and receiving an RAR and Msg4 on CORESET #0 during the random access procedure, by the UE; and
operation 4) operating by the UE in an initial downlink bandwidth part (DL BWP) indicated in SIB1 after the random access procedure (for example, after the UE receives RRC setup, RRC Resume, or RRC Reestablishment).

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In 5G Release 17 (R17), studies on a reduced capability UE (Redcap UE) have begun. Main use cases of the Redcap UE include industrial wireless sensors, surveillance cameras, and wearable devices. Characteristics of the Redcap UE are that its cost and complexity are lower than those of high-end enhanced mobile broadband (eMBB) and Ultra-Reliable Low-Latency Communications (URLLC) devices in Release 15/16 (R15/R16), its size is relatively small, requirement on service rate is low, and some devices require longer battery lives.

It was found by the inventors of this disclosure that if an initial DL BWP configured separately for the Redcap UE can be used during or before an initial access procedure, a network device and the Redcap UE need to have a consistent understanding of the initial downlink BWP or CORESET where the Redcap UE operates, such as when the Redcap UE starts to operate in the initial DL BWP separately configured for the Redcap UE, or when it starts to monitor a control resource set (CORESET) and/or a common search space (CSS) in the initial DL BWP separately configured for the Redcap UE, or which bandwidth the Redcap UE operates when it is in an idle state or an inactive state or before a random access procedure of radio resource control (RRC) connection reestablishment.

In existing techniques, for the case where the initial DL BWP configured separately for the Redcap UE is used during or before the initial access procedure, the network device and the Redcap UE do not have a consistent understanding of the initial downlink BWP or CORESET where the Redcap UE operates, thereby resulting in a loss or error in downlink transmission.

In order to solve at least one of the above problems or other similar problems, embodiments of this disclosure provide a method and apparatus for transceiving a signal and a communication system, wherein before random access is completed, a reduced capability UE (Redcap UE) receives a signal by using a first initial downlink BWP separately configured for the Redcap UE. Hence, a network device and the Redcap UE may have a consistent understanding of an initial downlink BWP or CORESET where the Redcap UE operates.

According to an aspect of the embodiments of this disclosure, there is provided an apparatus for transceiving a signal, applicable to a reduced capability UE (Redcap UE), the apparatus including a first transceiving unit configured to enable:
the Redcap UE to obtain configuration of a first initial downlink BWP, the first initial downlink BWP being an initial downlink BWP that is separately configured or defined for the Redcap UE; and
the Redcap UE to receive a signal by using the first initial downlink BWP before random access is completed.

According to another aspect of the embodiments of this disclosure, there is provided an apparatus for transceiving a signal, applicable to a network device, the apparatus including a second transceiving unit configured to enable the network device to:
transmit configuration of a first initial downlink BWP to a Redcap UE, the first initial downlink BWP being an initial downlink BWP that is separately configured or defined for the Redcap UE; and
transmit a signal to the Redcap UE by using the first initial downlink BWP before random access of the Redcap UE is completed.

According to a further aspect of the embodiments of this disclosure, there is provided an apparatus for transceiving a signal, applicable to a reduced capability UE (Redcap UE), the apparatus including a third transceiving unit configured to enable:
the Redcap UE to obtain configuration of a first initial downlink BWP, the first initial downlink BWP being an initial downlink BWP that is separately configured or defined for the Redcap UE; and
the Redcap UE to operate in a bandwidth when the Redcap UE is in an idle state or an inactive state or before a random access procedure of radio resource control (RRC) connection reestablishment, the bandwidth being one of at least one candidate bandwidth.

According to still another aspect of the embodiments of this disclosure, there is provided an apparatus for transceiving a signal, applicable to a network device, the apparatus including a fourth transceiving unit configured to enable the network device to:
transmit configuration of a first initial downlink BWP to a Redcap UE, the first initial downlink BWP being an initial downlink BWP that is separately configured or defined for the Redcap UE; and
indicate that the Redcap UE operates in a bandwidth when the Redcap UE is in an idle state or an inactive state or before a random access procedure of radio resource control (RRC) connection reestablishment, the bandwidth being one of at least one candidate bandwidth.

According to yet another aspect of the embodiments of this disclosure, there is provided an apparatus for transceiving a signal, applicable to a network device, the apparatus including a fifth transceiving unit configured to enable the network device to:
transmit configuration of a first initial downlink BWP to a Redcap UE, the first initial downlink BWP being an initial downlink BWP that is separately configured or defined for the Redcap UE;
receive a paging message from a core network; and
determine to transmit at least one bandwidth used by the paging message to the Redcap UE.

According to yet still another aspect of the embodiments of this disclosure, there is provided an apparatus for transceiving a signal, applicable to a reduced capability UE (Redcap UE), the apparatus including a sixth transceiving unit configured to enable:
the Redcap UE to obtain configuration of a first initial downlink BWP, the first initial downlink BWP being an initial downlink BWP that is separately configured or defined for the Redcap UE; and
the Redcap UE to receive a paging message from a network device.

An advantage of the embodiments of this disclosure exists in that before random access is completed, a Redcap UE receives a signal by using a first initial downlink BWP separately configured for the Redcap UE, whereby a network device and the Redcap UE may have a consistent understanding of an initial downlink BWP or CORESET where the Redcap UE operates.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a method for transceiving a signal of the embodiment of the first aspect of this disclosure;

FIG. 2 is a schematic diagram of using an initial DL BWP by a non-Redcap UE and using a first initial DL BWP by a Redcap UE;

FIG. 3 is a schematic diagram of a method for transceiving a signal of the embodiment of the first aspect of this disclosure;

FIG. 4 is a schematic diagram of a method for transceiving a signal of the embodiment of the third aspect of this disclosure;

FIG. 5 is a schematic diagram of a method for transceiving a signal of the embodiment of the fourth aspect of this disclosure;

FIG. 6 is a schematic diagram of using an initial DL BWP by a non-Redcap UE and using a first initial DL BWP by a Redcap UE;

FIG. 7 is a schematic diagram of a method for transceiving a signal of the embodiment of the fifth aspect of this disclosure;

FIG. 8 is a schematic diagram of a method for transceiving a signal of the embodiment of the sixth aspect of this disclosure;

FIG. 9 is a schematic diagram of an apparatus for transceiving a signal of the embodiment of the seventh aspect of this disclosure;

FIG. 10 is another schematic diagram of an apparatus for transceiving a signal of the embodiment of the seventh aspect of this disclosure;

FIG. 11 is a further schematic diagram of an apparatus for transceiving a signal of the embodiment of the seventh aspect of this disclosure;

FIG. 12 is a schematic diagram of an apparatus for transceiving a signal of the embodiment of the eighth aspect of this disclosure;

FIG. 13 is another schematic diagram of an apparatus for transceiving a signal of the embodiment of the eighth aspect of this disclosure;

FIG. 14 is a further schematic diagram of an apparatus for transceiving a signal of the embodiment of the eighth aspect of this disclosure;

FIG. 15 is a schematic diagram of a terminal equipment of the embodiment of the ninth aspect of this disclosure; and

FIG. 16 is a schematic diagram of a network device of the embodiment of the ninth aspect of this disclosure.

### DETAILED DESCRIPTION OF THE DISCLOSURE

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “according to” should be understood as “at least partially according to”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G and 5G and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: an integrated access and backhaul node (IAB-node), a base station (BS), an access point (AP), a transmission reception point (TRP), a broadcast transmitter, a mobile management entity (MME), a gateway, a server, a radio network controller (RNC), a base station controller (BSC).

The base station may include but not limited to a node B (NodeB or NB), an evolved node B (eNodeB or eNB), and a 5G base station (gNB). Furthermore, it may include a remote radio head (RRH), a remote radio unit (RRU), a relay, or a low-power node (such as a femto, and a pico). The term “base station” may include some or all of its functions, and each base station may provide communication coverage for a specific geographical area. And a term “cell” may refer to a base station and/or its coverage area, depending on a context of the term. Without confusion, terms “cell” and “base station” are interchangeable, and terms “signaling” and “message” are interchangeable.

In the embodiments of this disclosure, the term “user equipment (UE)” or “terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), an access terminal (AT), an IAB-MT, or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUSCH, and transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, higher-layer signaling may be, for example, radio resource control (RRC) signaling, such as being referred to as an RRC message, and including an MIB, system information, and a dedicated RRC message, or being referred to as an RRC IE (RRC information element). The higher-layer signaling may also be, for example, MAC (medium access control) signaling, or may be referred to as an MAC CE (MAC control element); however, this disclosure is not limited thereto.

In the embodiments of this disclosure, there may be following premises for an initial downlink BWP (DL BWP):
after initial access (e.g. after RRC setup, RRC Resume, or RRC Reestablishment), a Redcap UE is not expected to use the initial downlink BWP (DL BWP) that is wider than a maximum bandwidth of the Redcap UE; and
at least for TDD, the initial DL BWP of the Redcap UE (not exceeding the maximum bandwidth of the Redcap UE) may be optionally configured/defined, and is separated from an initial DL BWP of a non-Redcap UE,
wherein if an initial DL BWP of a separate Redcap UE is configured/defined, the initial DL BWP of this separate Redcap UE may be used at least after initial access (such as after RRC setup, RRC Resume, or RRC Resettlement).

### Embodiment of a First Aspect

The embodiment of the first aspect provides a method for transceiving a signal, applicable to a reduced capability UE (Redcap UE).

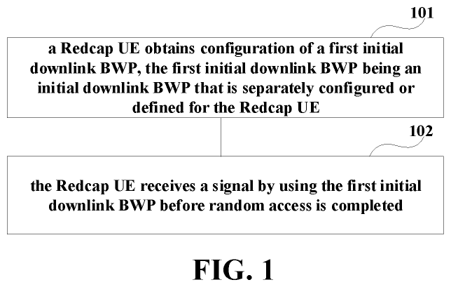

FIG. 1 is schematic diagram of a method for transceiving a signal of the embodiment of the first aspect of this disclosure. As shown in FIG. 1, the method includes:
operation 101: a Redcap UE obtains configuration of a first initial downlink BWP, the first initial downlink BWP being an initial downlink BWP that is separately configured or defined for the Redcap UE; and
operation 102: the Redcap UE receives a signal by using the first initial downlink BWP before random access is completed.

According to the embodiment of the first aspect, it may be determined when the Redcap UE starts to operate in the initial downlink BWP that is separately configured or defined for the Redcap UE. Hence, a network device side and the Redcap UE side may have a consistent understanding of the downlink operating BWP, thereby avoiding a loss or error in downlink transmission.

In operation 101, the Redcap UE may obtain the configuration of the first initial downlink BWP from the network device.

For example, SIB1 or other system information transmitted by the network device (such as a gNB) may include configuration of an initial DL BWP configured for a non-reduced capability terminal equipment (non-Redcap UE) and the configuration of the initial DL BWP separately configured or defined for the Redcap UE. The Redcap UE may ignore the configuration of the initial DL BWP configured for the non-Redcap UE, and take the initial DL BWP configured separately for the Redcap UE as an initial DL BWP of its own or take the configuration of the initial DL BWP configured separately for the Redcap UE as configuration of an initial DL BWP of its own, for example, the initial DL BWP has a BWP-id of 0; or, the Redcap UE may also use both the initial DL BWP configured for the non-Redcap UE and the initial DL BWP separately configured for the Redcap UE as initial DL BWPs of its own. The two initial DL BWPs may be distinguished by using different BWP-ids, for example, the initial DL BWP configured for the non-Redcap UE has a BWP-id of 0, and the initial DL BWP configured separately for the Redcap UE has a BWP-id of 5 or another value (which may be predefined or may be configured by the network device); or, the initial DL BWP configured separately for the Redcap UE has a BWP-id of 0, and the initial DL BWP configured separately for the Redcap UE has a BWP-id of 5 or another value (which may be predefined or may be configured by the network device).

In at least one embodiment, the configuration of the initial DL BWP separately configured or defined for the Redcap UE transmitted by the network device may include configuration of at least one CORESET (hereinafter referred to as a first CORESET) and/or configuration of at least one CSS (hereinafter referred to as a first CSS), which are used for the Redcap UE to receive system information (which may be system information including SIB1 or system information not including SIB1) and/or paging and/or a random access response (or random access message 2).

For the purpose of offloading, the initial DL BWP separately configured/defined for the Redcap UE may not include complete CORESET #0, that is, the initial DL BWP configured/defined separately for the Redcap UE may partially overlap or not overlap with CORESET #0 of the cell. In addition, the first CORESET may partially overlap or not overlap with CORESET #0 of the cell, and the first CSS may partially overlap or not overlap with SS #0 of the cell.

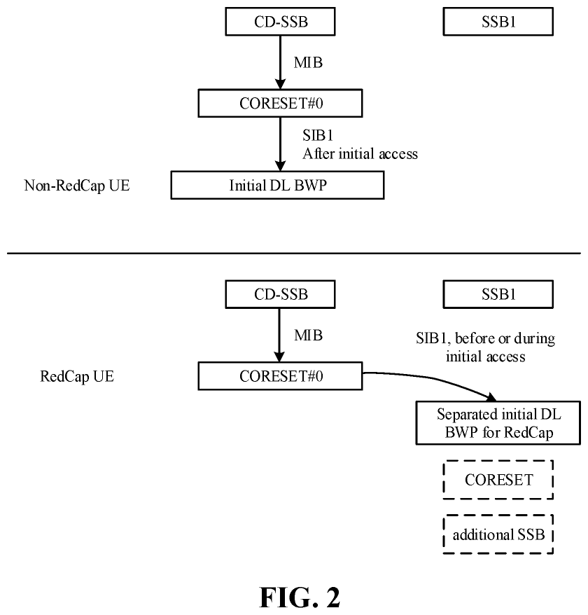

FIG. 2 is a schematic diagram of using the initial DL BWP by the non-Redcap UE and using the first initial DL BWP by the Redcap UE. FIG. 2 shows a case where the initial DL BWP (i.e. the first initial DL BWP) configured/defined separately for the Redcap UE does not overlap with CORESET #0 and the first CORESET does not overlap with CORESET #0 of the cell. However, this disclosure is not limited thereto, and the first initial DL BWP and CORESET #0 may also at least partially overlap.

The separated initial DL BWP for the RedCap in FIG. 2 is the first initial DL BWP, and the CORESET in the dashed box is the first CORESET.

According to operation 102, different from the non-Redcap UE, the Redcap UE may use the initial DL BWP (i.e., the first initial DL BWP) separately configured/defined for the Redcap UE configured by system information (such as SIB1 or other SIBs) before random access is completed (e.g. before or during a random access procedure).

In operation 102, the receiving a signal by using the initial downlink BWP separately configured/defined for the Redcap UE may include: receiving the signal in the initial DL BWP separately configured/defined for the Redcap UE, the received signal being, for example, a downlink reference signal and/or a physical downlink control channel (PDCCH), etc., such as a physical downlink shared channel (PDCCH) and/or a channel state information reference signal (CSI-RS); or, taking a bandwidth of the initial DL BWP separately configured/defined for the Redcap UE as a receiving bandwidth; or, monitoring a PDCCH in a CORESET and/or a CSS in the initial DL BWP separately configured for the Redcap UE; or, keeping or switching or adjusting the bandwidth by the Redcap UE to the initial DL BWP separately configured/defined for the Redcap UE, and so on. In addition, a meaning of “the receiving a signal by using the first initial downlink BWP” in this disclosure is not limited thereto.

A time of using the first initial downlink BWP by the Redcap UE shall be described below with reference to Implementation 1 and Implementation 2.

### Implementation 1

The reduced capability UE (Redcap UE) uses the first initial downlink BWP before an initial access procedure or a random access procedure.

The reduced capability UE may camp on the first initial downlink BWP before the initial access procedure or the random access procedure. For example, the Redcap UE camps on the first initial downlink BWP when it is in an idle state or an inactive state or before a random access procedure of radio resource control (RRC) connection reestablishment.

The Redcap UE may camp on the first initial downlink BWP after a suitable cell is selected or before initialization of the random access procedure.

In addition, the reduced capability UE may receive the signal by using the first initial downlink BWP upon reception of the configuration of the first initial downlink BWP or after receiving the configuration of the first initial downlink BWP. For example, the “upon reception of the configuration of the first initial downlink BWP or after receiving the configuration of the first initial downlink BWP” is an example of “before the random access procedure”.

For example, Redcap UE receives the configuration of the first initial downlink BWP in SIB1 or other system information, and uses the first initial downlink BWP upon or after receiving the configuration. Modifications shown in Table 1 may be made to TS38.331, wherein the underlined parts are newly-added contents.

TABLE 1
initialDownlinkBWP

The initial downlink BWP configuration for a PCell. The network
configures the locationAndBandwidth so that the initial
downlink BWP contains the entire CORESET#0 of this serving
cell in the frequency domain. The UE applies the
locationAndBandwidth upon reception of this field (e.g. to
determine the frequency position of signals described in
relation to this locationAndBandwidth) but it keeps
CORESET#0 until after reception of RRCSetup/
RRCResume/RRCReestablishment. The Redcap UE applies
and keeps the locationAndBandwidth upon
reception of this field.

For another example, the Redcap UE receives the configuration of the first initial downlink BWP in an RRC Release or RRC Release with suspend indication message, and uses the first initial downlink BWP upon or after reception of the configuration.

### Implementation 2

The reduced capability UE receives a signal by using the first initial downlink BWP during an initial access procedure or a random access procedure.

Implementation 2 may include following specific implementations 1-5.

### Specific Implementation 1:

The reduced capability UE receives a signal by using the first initial downlink BWP upon or after reception of the configuration of the first initial downlink BWP. For example, “upon or after reception of the configuration of the first initial downlink BWP” is an example of “during the initial access procedure”. For example, the Redcap UE uses the first initial downlink BWP upon reception of the configuration of the first initial downlink BWP in SIB1 or other system information and upon or after reception of the configuration.

In specific implementation 1, modifications shown in Table 1 may be made to TS38.331, wherein the underlined parts are newly-added contents.

### Specific Implementation 2:

The reduced capability UE receives a signal by using the first initial downlink BWP during or after an initialization procedure of a random access procedure.

For example, during the initialization procedure of the random access procedure, it may be that the reduced capability UE receives the signal by using the first initial downlink BWP when an initial uplink (UL) BWP separately configured for the Redcap UE is used, that is, when the reduced capability UE uses a first initial uplink BWP, the first initial uplink BWP being an initial uplink BWP separately configured or defined for the reduced capability UE.

In one embodiment of specific implementation 2, the first initial downlink BWP of the reduced capability UE has a predetermined identifier (BWP-id), which is, for example, BWP-id=0.

For example, if the Redcap UE deems that the initial DL BWP separately configured for the Redcap UE has a BWP-id of 0, there is no need to modify the BWP operation in Sub-section 5.15 of the MAC Specification, but it should be noted that the Redcap UE uses the initial DL BWP separately configured for the Redcap UE, that is, the Redcap UE may ignore the configuration of the initial DL BWP configured separately for the non-Redcap UE and take the initial DL BWP separately configured for the Redcap UE as an initial DL BWP with a BWP-id of 0 of its own.

In another embodiment of specific implementation 2, the first initial downlink BWP of the reduced capability UE corresponds to the first initial uplink BWP.

For example, if the Redcap UE deems that the BWP-id of the initial DL BWP separately configured for the Redcap UE is not 0, the BWP operation in Sub-section 5.15 of the MAC Specification is modified, for example, the modifications are those shown in Table 2 below; in addition, it is needed to specify that for the Redcap UE, the DL BWP corresponding to the initial UL BWP is the initial DL BWP separately configured for the Redcap UE, that is, the first initial downlink BWP corresponds to the first initial uplink BWP.

TABLE 2
Upon initiation of the Random Access procedure on a Serving Cell,
after the selection of carrier for performing Random Access
procedure as specified in clause 5.1.1, the MAC entity shall for
the selected carrier of this Serving Cell:

| 1> | if PRACH occasions are not configured for the active UL BWP: | |
|---|---|---|
| | 2> | switch the active UL BWP to BWP indicated |
| | | by initialUplinkBWP; |
| | 2> | if the Serving Cell is an SpCell: |

| | |
|---|---|
| 3> | switch the active DL BWP to BWP |
| | indicated by initialDownlinkBWP. |

| 1> | else: | |
|---|---|---|
| | 2> | if the Serving Cell is an SpCell: |

| | |
|---|---|
| 3> | if the active DL BWP does not have the |
| | same bwp-Id as the active UL BWP: |
| 4> | for a Redcap UE, switch the active |
| | DL BWP to the DL BWP corresponding |
| | to the active UL BWP as the active |
| | UL BWP. |

For another example, during the initialization procedure of the random access procedure, after setting a random access preamble power parameter, or after selecting a carrier for the random access, or after setting a type of the random access procedure (for example, the type is two-step random access or four-step random access), or after initializing a variable specific to the type of the random access, the Redcap UE may switch the downlink BWP to the first initial downlink BWP, or adjust the receiving bandwidth to the first initial downlink BWP.

For a further example, after the initialization procedure of the random access procedure, before executing a random access resource selection procedure, the Redcap UE may switch the downlink BWP to the first initial downlink BWP, or adjust the receiving bandwidth to the first initial downlink BWP.

In specific implementations 1 and 2, the network device may transmit an additional SSB in the first initial downlink BWP, and the Redcap UE may receive the additional SSB in the first initial downlink BWP. Therefore, the reduced capability UE may select an SSB according to a measurement result of the SSB in the first initial downlink BWP during the random access resource selection procedure in the random access procedure. Wherein, the additional SSB may be the additional SSB shown in FIG. 2.

### Specific Implementation 3:

The reduced capability UE receives the signal by using the first initial downlink BWP during or after the random access resource selection procedure.

For example, the reduced capability UE receives the signal by using the first initial downlink BWP after the SSB is selected; more specifically, in the random access resource selection procedure, the reduced capability UE receives the signal after selecting the SSB from SSBs defined by the cell or from SSBs in the initial downlink BWP configured for the non-Redcap UE.

For another example, the reduced capability UE receives the signal by using the first initial downlink BWP after selecting a random access preamble group (Group A or Group B), or after selecting a random access preamble, or after determining a next available physical random access channel (PRACH) occasion.

### Specific Implementation 4:

The reduced capability UE receives the signal by using the first initial downlink BWP before or upon reception of a random access response.

That before reception of a random access response includes after transmitting a random access message 1 (Msg1, preamble) or a random access message A (preamble+PUSCH), such as after transmitting a first random access message 1 (Msg1, preamble) or a random access message A (preamble+PUSCH).

That upon reception of a random access response includes upon starting a random access response window (ra-ResponseWindow), such as upon starting the random access response window for the first time.

In specific implementations 1-4, random access message 1 (Msg1, preamble) or random access message A (preamble+PUSCH) indicates a type of the reduced capability UE, i.e. indicating that the terminal equipment is a Redcap UE, and/or indicating the number of receiving antennas of the reduced capability UE, such as 1 Rx or 2 Rx. Hence, the network device may determine the initial DL BWP to which the Redcap UE corresponds, so as to transmit Msg2 and/or Msg4 in a correct BWP.

### Specific Implementation 5:

The reduced capability UE receives the signal by using the first initial downlink BWP upon or after transmission of random access message 3 (Msg3).

In specific implementation 5, Msg4 may be transmitted in the initial DL BWP separately configured for the Redcap UE, while Msg2 may not be transmitted in the initial DL BWP separately configured for the Redcap UE.

In specific implementation 5, random access message 1 (Msg1, preamble) or random access message A (preamble+PUSCH) or random access message 3 indicates a type of the reduced capability UE, i.e. indicating that the terminal equipment is a Redcap UE, and/or indicating the number of receiving antennas of the reduced capability UE, such as 1 Rx or 2 Rx. Hence, the network device may determine the initial DL BWP to which the Redcap UE corresponds, so as to transmit Msg4 in a correct BWP.

In specific implementations 3-5, the network device may not transmit an additional SSB in the first initial DL BWP, and the Redcap UE may not receive an additional SSB in the first initial DL BWP.

In the embodiment of the first aspect, the reduced capability UE may use the relevant configuration of the random access in the initial uplink BWP configuration configured for the non-RedCap, or use the relevant configuration of the random access in the initial uplink BWP separately configured or defined for the Redcap UE. If the initial uplink BWP is separately configured or defined for the Redcap UE, the relevant configuration of the random access may include at least one parameter in a RACH ConfigCommon IE.

In the embodiment of the first aspect, before the random access is completed, the Redcap UE receives the signal by using the first initial downlink BWP. Hence, the network device side and the UE side may have a consistent understanding of the downlink operating BWP, thereby avoiding a loss or error in downlink transmission.

### Embodiment of a Second Aspect

Addressed to the same problem as the embodiment of the first aspect, the embodiment of the second aspect provides a method for transceiving a signal, applicable to a network device. The method for transceiving a signal in the embodiment of the second aspect corresponds to the method for transceiving a signal in the embodiment of the first aspect.

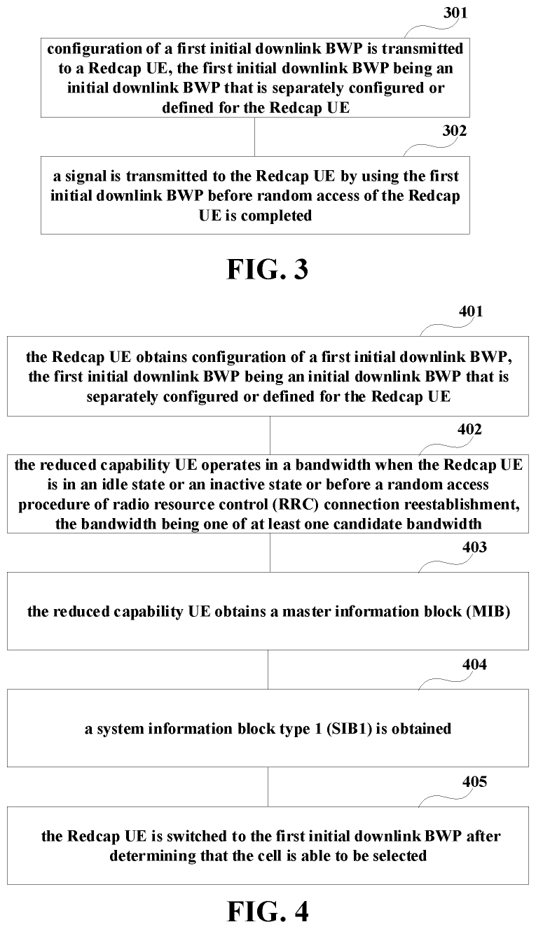

As shown in FIG. 3, the method for transceiving a signal includes:
operation 301: configuration of a first initial downlink BWP is transmitted to a Redcap UE, the first initial downlink BWP being an initial downlink BWP that is separately configured or defined for the Redcap UE; and
operation 302: a signal is transmitted to the Redcap UE by using the first initial downlink BWP before random access of the Redcap UE is completed.

In at least one embodiment, the configuration of the first initial downlink BWP transmitted to the Redcap UE includes: configuration of at least one control resource set (CORESET) (hereinafter referred to as a first CORESET) and/or configuration of at least one common search space (CSS) (hereinafter referred to as a first CSS). For example, the control resource set (CORESET) and/or the common search space (CSS) is/are used for the Redcap UE upon reception of system information (which may system information including or not including SIB1) and/or paging and/or a random access response (or random access message 2).

In operation 301, the configuration of the first initial downlink BWP is transmitted to the Redcap UE via the system information or RRC dedicated signaling.

A time of using the first initial downlink BWP by the network device to transmit the signal to the Redcap UE shall be described below with reference to Implementation 1 and Implementation 2.

### Implementation 1

The reduced capability UE (Redcap UE) transmits the signal by using the first initial downlink BWP before an initial access procedure or a random access procedure.

### Implementation 2

The reduced capability UE transmits a signal by using the first initial downlink BWP during an initial access procedure or a random access procedure.

Implementation 2 may include following specific implementations 1-5.

### Specific Implementation 1:

The signal is transmitted by using the first initial downlink BWP upon or after transmission of the configuration of the first initial downlink BWP to the reduced capability UE.

### Specific Implementation 2:

The signal is transmitted by using the first initial downlink BWP during or after an initialization procedure of a random access procedure of the reduced capability UE.

For example, when the reduced capability UE uses a first initial uplink BWP, it transmits the signal by using the first initial downlink BWP, wherein the first initial uplink BWP is an initial uplink BWP separately configured or defined for the reduced capability UE.

In one embodiment of specific implementation 2, the first initial downlink BWP of the reduced capability UE has a predetermined identifier (BWP-id), which is, for example, BWP-id=0.

In another embodiment of specific implementation 2, the first initial downlink BWP of the reduced capability UE corresponds to the first initial uplink BWP, wherein the first initial uplink BWP is an initial uplink BWP separately configured or defined for the reduced capability UE.

In specific implementations 1 and 2, the network device may also transmit an additional SSB to the reduced capability UE by using the first initial downlink BWP.

### Specific Implementation 3:

During a random access resource selection procedure or after a random access resource selection procedure of the reduced capability UE, the network device transmits the signal by using the first initial downlink BWP.

For example, the network device transmits the signal by using the first initial downlink BWP after an SSB is selected from SSBs defined by the cell. More specifically, in the random access resource selection procedure, the network device transmits the signal by using the first initial downlink BWP after the reduced capability UE selects the SSB from the SSBs defined by the cell or from SSBs in the initial downlink BWP configured for the non-Redcap UE.

For another example, the network device transmits the signal by using the first initial downlink BWP after the reduced capability UE selects a random access preamble group (Group A or Group B), or after selecting a random access preamble, or after determining a next available physical random access channel (PRACH) occasion.

### Specific Implementation 4:

The network device transmits the signal by using the first initial downlink BWP before or upon transmission of a random access response to the reduced capability UE.

That before transmission of a random access response includes after reception of a random access message 1 (Msg1, preamble) or a random access message A (preamble+PUSCH), such as after reception of a first random access message 1 (Msg1, preamble) or a random access message A (preamble+PUSCH).

That upon transmission of a random access response includes upon starting a random access response window (ra-ResponseWindow) by the reduced capability UE, such as upon starting the random access response window for the first time.

In specific implementations 1-4, random access message 1 (Msg1, preamble) or random access message A (preamble+PUSCH) indicates a type of the reduced capability UE, i.e. indicating that the terminal equipment is a Redcap UE, and/or indicating the number of receiving antennas of the reduced capability UE, such as 1 Rx or 2 Rx. Hence, the network device may determine the initial DL BWP to which the Redcap UE corresponds, so as to transmit Msg2 and/or Msg4 in a correct BWP.

### Specific Implementation 5:

The network device transmits the signal by using the first initial downlink BWP upon or after reception of random access message 3 (Msg3).

In specific implementation 5, random access message 1 (Msg1, preamble) or random access message A (preamble+PUSCH) or random access message 3 indicates a type of the reduced capability UE, and/or indicates the number of receiving antennas of the reduced capability UE, such as 1 Rx or 2 Rx. Hence, the network device may determine the initial DL BWP to which the Redcap UE corresponds, so as to transmit Msg4 in a correct BWP.

In specific implementations 3-5, the network device may not transmit an additional SSB in the first initial DL BWP, and the Redcap UE may not receive an additional SSB in the first initial DL BWP.

In the embodiment of the second aspect, before the random access is completed, the Redcap UE transmits the signal by using the first initial DL BWP. Hence, the network device side and the UE side may have a consistent understanding of the downlink operating BWP, thereby avoiding a loss or error in downlink transmission.

### Embodiment of a Third Aspect

The embodiment of the third aspect provides a method for transceiving a signal, applicable to a reduced capability UE (Redcap UE).

FIG. 4 is schematic diagram of the method for transceiving a signal of the embodiment of the third aspect. As shown in FIG. 4, the method for transceiving a signal includes:
operation 401: the Redcap UE obtains configuration of a first initial downlink BWP, the first initial downlink BWP being an initial downlink BWP that is separately configured or defined for the Redcap UE; and
operation 402: the reduced capability UE operates in a bandwidth when the Redcap UE is in an idle state or an inactive state or before a random access procedure of radio resource control (RRC) connection reestablishment, the bandwidth being one of at least one candidate bandwidth.

In operation 402, the idle state refers to an RRC_IDLE state, and the inactive state refers to an RRC_INACTIVE state.

In operation 402, the before a random access procedure of radio resource control (RRC) connection reestablishment is, for example, at least one of the following: during initiation of an RRC connection reestablishment procedure, during operation of timer T311, during a cell selection procedure, when a suitable cell is selected, or before initialization of a random access (RA) procedure, etc.

In operation 402, the Redcap UE operates in a bandwidth. Here, “operates in a bandwidth” may also be understood as including “camp on a bandwidth”, “keep a bandwidth”, “use a bandwidth”, “receive a PDCCH and/or a PDSCH and/or a reference signal within a bandwidth”, “switching to a bandwidth”, or “retuning an RF to a bandwidth”, etc.

In at least one embodiment, the at least one candidate bandwidth in operation 402 includes:
a control resource set 0 (CORESET #0); an initial downlink BWP to which a non-Redcap UE corresponds; and the first initial downlink BWP or a control resource set (CORESET) in the first initial downlink BWP used for receiving system information and/or paging and/or a random access response.

That is,
in embodiment 1, the Redcap UE may camp on CORESET #0, that is, the Redcap UE may camp on CORESET #0 together with the non-Redcap UE;
in embodiment 2, the Redcap UE may camp on the initial DL BWP corresponding to the non-Redcap UE, wherein “the initial DL BWP corresponding to the non-Redcap UE” may refer to “the initial DL BWP configured for the non-Redcap UE”, and “the initial DL BWP configured for the non-Redcap UE” is the initial downlink BWP (initial DL BWP) configured by the cell in SIB1, and the Redcap UE may operate in this initial DL BWP, such as when the bandwidth of the BWP is not greater than a maximum bandwidth supported by the Redcap UE;
in embodiment 3, the Redcap UE may camp on the initial DL BWP (i.e. the first initial DL BWP) separately configured/defined for the Redcap UE, and may also operate in the CORESET in the initial DL BWP used for receiving system information and/or paging.

For example, in embodiment 3, the method for transceiving a signal in FIG. 4 may further include:
operation 403: the reduced capability UE obtains a master information block (MIB);
operation 404: a system information block type 1 (SIB1) is obtained; and
operation 405: the Redcap UE is switched to the first initial downlink BWP after determining that the cell is able to be selected.

For example, in embodiment 3, cell selection is needed when the terminal equipment enters into the RRC_IDLE or RRC_INACTIVE state or when RRC reestablishment is needed (except for such special cases as inter-RAT cell reselection, etc.), and MIB and SIB1 shall be read during the cell selection procedure. In New Radio (NR), for a cell, only one CD-SSB is configured for the terminal equipment. Therefore, the Redcap UE needs to read the CD-SSB to obtain the MIB, and monitor a PDCCH from CORESET #0 to obtain SIB1, so as to select a cell. If the initial DL BWP configured/defined for the Redcap UE does not include complete CORESET #0, the Redcap UE may first read the CD-SSB to obtain the MIB, and monitors the PDCCH in CORESET #0 and/or SS #0 to obtain SIB1, so as to determine that the cell may be selected, for example, the cell is a suitable cell, and the Redcap UE is switched to/operate in the initial DL BWP configured/defined for the Redcap UE.

In at least one embodiment, the reduced capability UE may determine the operating bandwidth in the above at least one candidate bandwidth, such as determining the bandwidth according to a preset condition. Therefore, the network device side may also determine the bandwidth according to the preset condition, thereby having the same understanding of the operating bandwidth as the Redcap UE.

Alternatively, in at least another embodiment, the Redcap UE may also determine the bandwidth according to indication information of the network device. The indication information may be transmitted via the following information or messages: system information (such as SIB1 or other SIBs), a radio resource control release/RRC release with suspend indication message, a radio resource control reject message, or a radio resource control reconfiguration message, etc.

With the embodiment of the third aspect, the network side and terminal side may determine the idle or inactive state or the bandwidth or BWP where the Redcap UE needing to perform RRC reestablishment operates, which is beneficial for the network side and the UE side to have a consistent understanding of the bandwidth or BWP where the Redcap UE operates, and the downlink message and information that the Redcap UE needs to receive may be correctly transmitted to the Redcap UE.

In addition, the embodiment of the third aspect may be combined with the embodiment of the first aspect. Therefore, in the case where the Redcap UE is configured with the first initial DL BWP, the network side and the terminal side may have a consistent understanding of when the Redcap UE uses the first initial DL BWP and the bandwidth on which the Redcap UE camps, thereby avoiding a loss or error in downlink transmission.

### Embodiment of a Fourth Aspect

Addressed to the same problem as the embodiment of the third aspect, the embodiment of the fourth aspect provides a method for transceiving a signal, applicable to a network device. The method for transceiving a signal in the embodiment of the fourth aspect corresponds to the method for transceiving a signal in the embodiment of the third aspect.

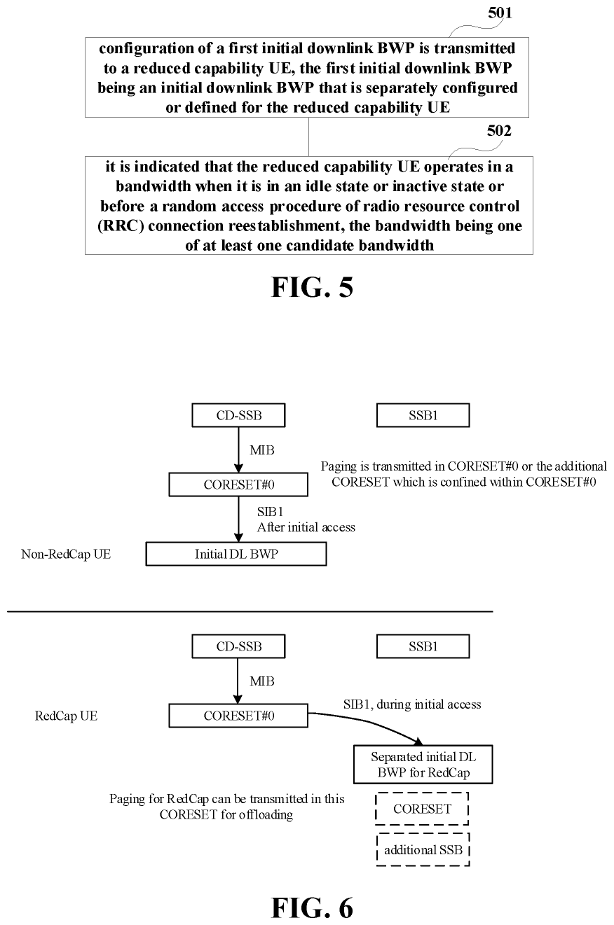

As shown in FIG. 5, the method for transceiving a signal includes:
operation 501: configuration of a first initial downlink BWP is transmitted to a reduced capability UE, the first initial downlink BWP being an initial downlink BWP that is separately configured or defined for the reduced capability UE; and
operation 502: it is indicated that the reduced capability UE operates in a bandwidth when it is in an idle state or inactive state or before a random access procedure of radio resource control (RRC) connection reestablishment, the bandwidth being one of at least one candidate bandwidth.

In operation 502, the idle state refers to an RRC_IDLE state, and the inactive state refers to an RRC_INACTIVE state.

In operation 502, the before a random access procedure of radio resource control (RRC) connection reestablishment is, for example, at least one of the following: during initiation of an RRC connection reestablishment procedure, during operation of timer T311, during a cell selection procedure, when a suitable cell is selected, or before initialization of a random access (RA) procedure, etc.

In this disclosure, the Redcap UE operates in a bandwidth. Here, “operates in a bandwidth” may also be understood as including “camp on a bandwidth”, “keep a bandwidth”, “use a bandwidth”, “receive a PDCCH and/or a PDSCH and/or a reference signal within a bandwidth”, “switching to a bandwidth”, or “retuning an RF to a bandwidth”, etc.

In operation 502, the at least one candidate bandwidth includes:
a control resource set 0 (CORESET #0);
an initial downlink BWP to which a non-Redcap UE corresponds; and
the first initial downlink BWP or a control resource set (CORESET) in the first initial downlink BWP used for receiving system information and/or paging and/or a random access response.

In operation 502, the indication information is transmitted via the following information or messages:
system information (such as SIB1 or other SIBs), an RRC release/RRC release with suspend indication message, an RRC reject message or an RRC reconfiguration message.

Furthermore, in at least one embodiment, the network device may determine the bandwidth, and the Redcap UE may also determine the bandwidth according to the preset condition. Therefore, the network device and the Redcap UE may have the same understanding of the camping bandwidth, in which case operation 502 may be omitted.

With the embodiment of the fourth aspect, the network side and terminal side may determine the idle/inactive state(s) or the bandwidth or BWP where the Redcap UE needing to perform RRC reestablishment operates, which is beneficial for the network side and the UE side to have a consistent understanding of the bandwidth or BWP where the Redcap UE operates, and the downlink message and information that the Redcap UE needs to receive may be correctly transmitted to the Redcap UE.

In addition, the embodiment of the fourth aspect may be combined with the embodiment of the second aspect. Therefore, in the case where the Redcap UE is configured with the first initial DL BWP, the network side and the terminal side may have a consistent understanding of when the Redcap UE uses the first initial DL BWP and the bandwidth on which the Redcap UE camps, thereby avoiding a loss or error in downlink transmission.

### Embodiment of a Fifth Aspect

The embodiment of the fifth aspect of this disclosure provides a method for transceiving a signal, applicable to a network device. In the embodiment of the fifth aspect, the network device is represented by a gNB.

As explained in the embodiment of the first aspect, for the purpose of offloading, the initial DL BWP separately configured or defined for the Redcap UE (i.e. the first initial DL BWP) may not include complete CORESET #0, that is, the initial DL BWP separately configured/defined for the Redcap UE may partially overlap or not overlap with CORESET #0 of the cell, in which case when there is a paging message in a core network that is transmitted to the network device (e.g. gNB), the network device (e.g. gNB) needs to determine a bandwidth or BWP or CORESET in which the paging message is transmitted. FIG. 6 is a schematic diagram of using an initial DL BWP by a non-Redcap UE and using a first initial DL BWP by a Redcap UE. In FIG. 6, a case where the initial DL BWP (i.e. the first initial DL BWP) separately configured/defined for the Redcap UE does not overlap with CORESET #0 is shown.

For paging initiated by a radio access network (RAN), as the gNB has a context of the UE, it learns whether a paging message is for the Redcap UE. Therefore, gNB may transmit the paging message in the BW where the Redcap UE in the RRC_INACTIVE state camps (reference may be made to the embodiment of the second aspect).

However, for paging initiated by a core network (CN), the gNB is unable to obtain information on whether the paging message transmitted from the core network is for the Redcap UE. Therefore, there exists a problem that the gNB is unable to determine a bandwidth or BWP or CORESET in which the paging message is transmitted.

Addressed to the above problem, the embodiment of the fifth aspect of this disclosure provides a method for transceiving a signal.

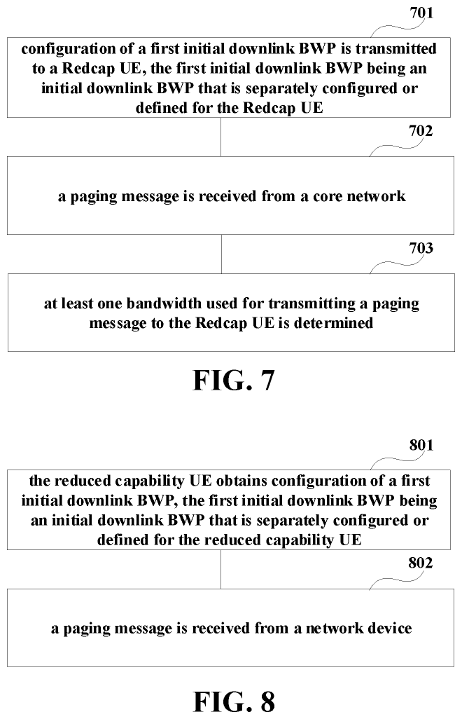

FIG. 7 is a schematic diagram of a method for transceiving a signal of the embodiment of the fifth aspect. As shown in FIG. 7, the method includes:
operation 701: configuration of a first initial downlink BWP is transmitted to a Redcap UE, the first initial downlink BWP being an initial downlink BWP that is separately configured or defined for the Redcap UE;
operation 702: a paging message is received from a core network; and
operation 703: at least one bandwidth used for transmitting a paging message to the Redcap UE is determined.

After operation 703, a network device may transmit the paging message to the reduced capability UE according to the bandwidth determined in operation 703.

In this embodiment, the reduced capability UE may be in an RRC_IDLE state or an RRC_INACTIVE state.

In this disclosure, operation 703 may be executed in any one of the following implementations 1-3.

### Implementation 1:

In Implementation 1, the bandwidth determined in operation 703 includes:
an initial downlink BWP of a non-Redcap UE, or a control resource set 0 (CORESET #0), or an additional control resource set (additional CORESET) in the initial downlink BWP of a non-Redcap UE.

For example, the network device may transmit the paging message in the initial DL BWP of the non-Redcap UE or CORESET #0 or the additional CORESET in the initial DL BWP of non-Redcap UE.

The Redcap UE may need to retune a radio frequency (RF) to CORESET #0 according to paging occasions (POs) to which it corresponds, so as to receive the paging message, such as in a case where the Redcap UE in the RRC_IDLE or RRC_INACTIVE state camps on the initial DL BWP separately configured or defined for the Redcap UE and the initial DL BWP does not contain complete CORESET #0 or a CORESET for a paging message in the initial DL BWP to which the non-Redcap UE corresponds.

### Implementation 2:

In Implementation 2, the bandwidth determined in operation 703 includes:
an initial downlink BWP of a non-Redcap UE, or a control resource set 0 (CORESET #0), or an additional control resource set (additional CORESET) in the initial downlink BWP of a non-Redcap UE, and an initial downlink BWP separately configured or defined for the Redcap UE or a control resource set (CORESET) separately configured or defined for the Redcap UE.

For example, the network device may transmit the paging message in the initial DL BWP of the non-Redcap UE or CORESET #0 or the additional CORESET in the initial DL BWP of the non-Redcap UE, and the initial DL BWP separately configured/defined for the Redcap UE or the CORESET separately configured/defined for the Redcap UE.

In at least one embodiment, in a case where both the initial downlink BWP of the non-Redcap UE and the initial downlink BWP of the Redcap UE include the control resource set 0 (CORESET #0) or an additional control resource set (CORESET) for paging, the network device may transmit a paging message to the Redcap UE and the non-Redcap UE in the control resource set 0 (CORESET #0) or the additional control resource set (CORESET) used for paging.

In at least another embodiment, in a case where at least one of the initial downlink BWP of the non-Redcap UE and the initial downlink BWP of the Redcap UE does not include the control resource set 0 (CORESET #0) or an additional control resource set (CORESET) for paging, the network device transmits a paging message by using the initial downlink BWP of the non-Redcap UE, or the control resource set 0 (CORESET #0) or the additional control resource set (additional CORESET) in the initial downlink BWP of the non-Redcap UE and the initial downlink BWP separately configured or defined for the Redcap UE or the control resource set (CORESET) separately configured or defined for the Redcap UE.

For example, if both of the initial DL BWPs contain CORESET #0 or the additional CORESET for paging, the paging messages for the Redcap UE and the non-Redcap UE may be transmitted in CORESET #0 or in the additional CORESET for paging; otherwise, the paging messages need to be transmitted in both of the initial DL BWPs or the CORESETs (CORESET #0 and the additional CORESET used for paging) in the two initial DL BWPs.

### Implementation 3:

In Implementation 3, the bandwidth determined in operation 703 includes:
an initial downlink BWP separately configured or defined for the Redcap UE, or a control resource set (CORESET) separately configured or defined for the Redcap UE.

For example, the network device transmits the paging message in the initial DL BWP separately configured/defined for the Redcap UE or in the CORESET separately configured/defined for the Redcap UE.

In addition, in the case of implementation 3, the network device may further transmit the paging message for the non-Redcap UE by using the initial downlink BWP separately configured or defined for the non-Redcap UE, or the control resource set (CORESET) separately configured or defined for the non-Redcap UE.

In the case of implementation 3, the network device may receive an indication from a core network, the indication being used to indicate whether the paging message is a paging message used for the Redcap UE. Therefore, in the case where the initial DL BWP (i.e. the first initial DL BWP) separately configured/defined for the Redcap UE does not include complete CORESET #0 or a complete additional CORESET for paging, the network device may determine whether the paging message is for the Redcap UE according to the indication message.

In a specific instance, times of a paging message for paging the Redcap UE and a paging message for paging the non-Redcap UE transmitted by the core network are different, and/or structures and/or contained information elements (IEs) of the paging messages are different.

For example, the core network (CN) may transmit the paging message for paging the Redcap UE and the paging message for paging the non-Redcap UE to the network device (such as a gNB) separately via different messages; or, the core network may distinguish the paging message for paging the Redcap UE and the paging message for paging the non-Redcap UE via different structures or IEs in the paging messages, such as Redcap UE-specific paging assistant information and/or Redcap UE-specific paging discontinuous reception (DRX) information contained in a core network (CN) paging message; or, the core network may use an indicator (for example, the indicator may be of 1 bit) to indicate that the paging message is for the Redcap UE, or the indicator may be used to indicate that a paging record is for the Redcap UE. After receiving a paging message, the network device (gNB) may determine whether the paging message is used to page the Redcap UE or the non-Redcap UE or which paging records in the paging message are used to page the Redcap UE according to a reception time and/or a structure and/or a contained IE of the message, and transmit the paging message for paging the Redcap UE to the Redcap UE at a paging occasion to which the Redcap UE corresponds.

In a scenario of split of a centralized unit and a distributed unit (CU-DU split), the indication may be transmitted via an F1 interface message. For example, the network device may include a centralized unit (CU) and a distributed unit (DU), the CU transmitting the indication to the DU via the F1 interface message.

According to the embodiment of the fifth aspect, the network device may determine a bandwidth or a BWP or a CORESET in which the paging message transmitted by the core network for the reduced capability UE is transmitted.

### Embodiment of a Sixth Aspect

The embodiment of the sixth aspect provides a method for transceiving a signal, applicable to a reduced capability UE. The method for transceiving a signal in the embodiment of the six aspect corresponds to the method for transceiving a signal in the embodiment of the fifth aspect.

FIG. 8 is a schematic diagram of a method for transceiving a signal of the embodiment of the sixth aspect. As shown in FIG. 8, the method includes:
operation 801: the reduced capability UE obtains configuration of a first initial downlink BWP, the first initial downlink BWP being an initial downlink BWP that is separately configured or defined for the reduced capability UE; and
operation 802: a paging message is received from a network device.

In this embodiment, the reduced capability UE may be in an RRC_IDLE state or an RRC_INACTIVE state.

In at least one embodiment, the paging message in operation 802 is, for example, a paging message transmitted by the core network to the network device (e.g. a gNB) and forwarded by the network device to the Redcap UE.

In implementation 1 of operation 802, a bandwidth receiving the paging message includes: the initial downlink BWP, or the control resource set 0 (CORESET #0), of the non-Redcap UE, or the additional control resource set (additional CORESET) in the initial downlink BWP of the non-Redcap UE.

In implementation 1 of operation 802, the reduced capability UE may retune a radio frequency to the initial downlink BWP, or CORESET #0, of the non-Redcap UE, or the additional control resource set (additional CORESET) in the initial downlink BWP of the non-Redcap UE according to corresponding paging occasions (POs), so as to receive the paging message, such as in a case where the Redcap UE in the RRC_IDLE or RRC_INACTIVE state camps on the initial DL BWP separately configured or defined for the Redcap UE and the initial DL BWP does not contain complete CORESET #0 or a CORESET for a paging message in the initial DL BWP to which the non-Redcap UE corresponds.

In implementation 2 of operation 802, the bandwidth receiving the paging message includes: the initial downlink BWP, or the control resource set 0 (CORESET #0), of the non-Redcap UE, or the additional control resource set (additional CORESET) in the initial downlink BWP of the non-Redcap UE, and an initial downlink BWP separately configured or defined for the Redcap UE or a control resource set (CORESET) separately configured or defined for the Redcap UE.

In implementation 3 of operation 802, the bandwidth receiving paging messages includes: an initial downlink BWP separately configured or defined for the reduced capability UE, or a control resource set CORESET separately configured or defined for the reduced capability UE.

According to the embodiment of the sixth aspect, the terminal equipment may determine a bandwidth or a BWP or a CORESET in which the paging message transmitted by the core network to the reduced capability UE is received.

### Embodiment of a Seventh Aspect

The embodiment of this disclosure provides an apparatus for transceiving a signal, applicable to a reduced capability UE (Redcap UE).

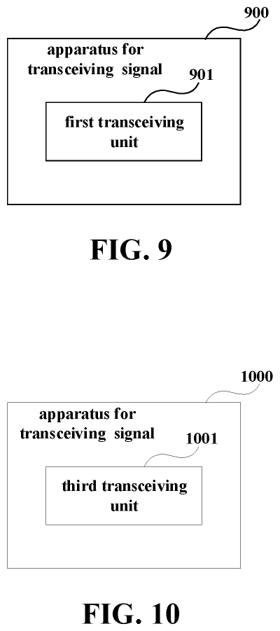

FIG. 9 is a schematic diagram of an apparatus for transceiving a signal of the embodiment of the seventh aspect. As shown in FIG. 9, an apparatus 900 for transceiving a signal includes a first transceiving unit 901 configured to enable:
the Redcap UE to obtain configuration of a first initial downlink BWP, the first initial downlink BWP being an initial downlink BWP that is separately configured or defined for the Redcap UE; and
the Redcap UE to receive a signal by using the first initial downlink BWP before random access is completed.

Reference may be made to the embodiment of the first aspect for explanations of the apparatus 900 for transceiving a signal.

FIG. 10 is another schematic diagram of an apparatus for transceiving a signal of the embodiment of the seventh aspect. As shown in FIG. 10, an apparatus 1000 for transceiving a signal includes a third transceiving unit 1001 configured to enable:
the Redcap UE to obtain configuration of a first initial downlink BWP, the first initial downlink BWP being an initial downlink BWP that is separately configured or defined for the Redcap UE; and
the Redcap UE to operate in a bandwidth when the Redcap UE is in an idle state or an inactive state or before a random access procedure of radio resource control (RRC) connection reestablishment, the bandwidth being one of at least one candidate bandwidth.

Reference may be made to the embodiment of the third aspect for explanations of the apparatus 1000 for transceiving a signal.

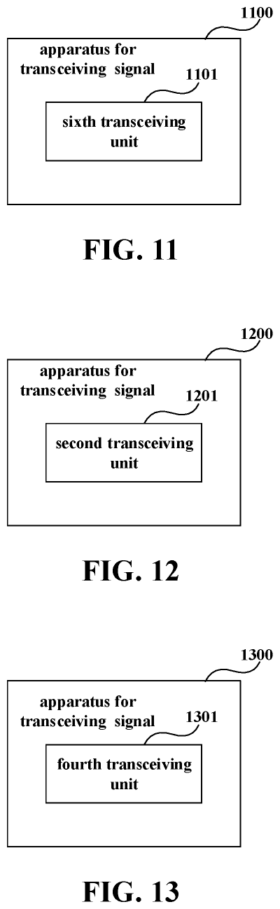

FIG. 11 is a further schematic diagram of an apparatus for transceiving a signal of the embodiment of the seventh aspect. As shown in FIG. 11, an apparatus 1100 for transceiving a signal includes a sixth transceiving unit 1101 configured to enable:
the Redcap UE to obtain configuration of a first initial downlink BWP by the reduced capability UE, the first initial downlink BWP being an initial downlink BWP that is separately configured or defined for the reduced capability UE; and
the Redcap UE to receive a paging message from a network device.

Reference may be made to the embodiment of the sixth aspect for explanations of the apparatus 1100 for transceiving a signal.

### Embodiment of an Eighth Aspect

The embodiment of this disclosure provides an apparatus for transceiving a signal, applicable to a network device, such as a gNB.

FIG. 12 is a schematic diagram of an apparatus for transceiving a signal of the embodiment of the eighth aspect. As shown in FIG. 12, an apparatus 1200 for transceiving a signal includes a second transceiving unit 1201 configured to enable the network device to:
transmit configuration of a first initial downlink BWP to a Redcap UE, the first initial downlink BWP being an initial downlink BWP that is separately configured or defined for the Redcap UE; and
transmit a signal to the Redcap UE by using the first initial downlink BWP before random access of the Redcap UE is completed.

Reference may be made to the embodiment of the second aspect for explanations of the apparatus 1200 for transceiving a signal.

FIG. 13 is another schematic diagram of an apparatus for transceiving a signal of the embodiment of the eighth aspect. As shown in FIG. 13, an apparatus 1300 for transceiving a signal includes a fourth transceiving unit 1301 configured to enable the network device to:
transmit configuration of a first initial downlink BWP to a reduced capability UE, the first initial downlink BWP being an initial downlink BWP that is separately configured or defined for the reduced capability UE; and
indicate that the reduced capability UE operates in a bandwidth when it is in an idle state or inactive state or before a random access procedure of radio resource control (RRC) connection reestablishment, the bandwidth being one of at least one candidate bandwidth.

Reference may be made to the embodiment of the fourth aspect for explanations of the apparatus 1300 for transceiving a signal.

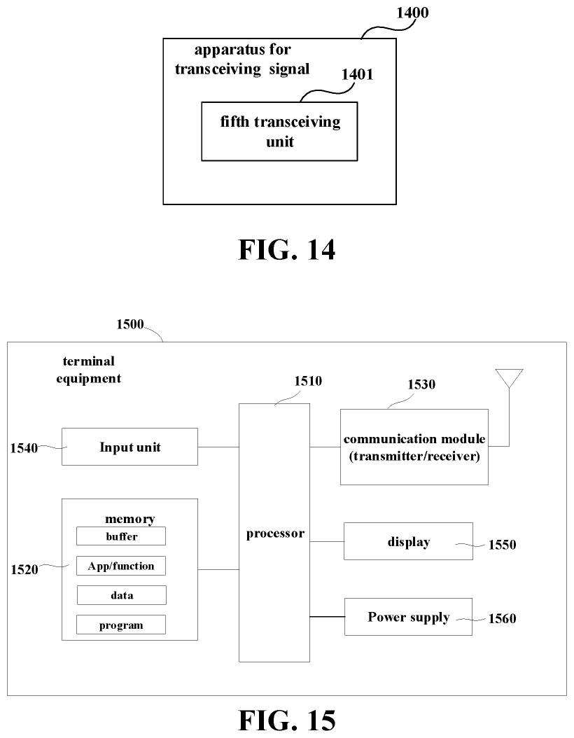

FIG. 14 is a further schematic diagram of an apparatus for transceiving a signal of the embodiment of the eighth aspect. As shown in FIG. 14, an apparatus 1400 for transceiving a signal includes a fifth transceiving unit 1401 configured to enable the network device to:
transmit configuration of a first initial downlink BWP to a Redcap UE, the first initial downlink BWP being an initial downlink BWP that is separately configured or defined for the Redcap UE;
receive a paging message from a core network; and
determine at least one bandwidth used for transmitting a paging message to the Redcap UE.

Reference may be made to the embodiment of the fifth aspect for explanations of the apparatus 1400 for transceiving a signal.

### Embodiment of a Ninth Aspect

The embodiment of this disclosure provides a communication system, including a reduced capability UE and a network device.

FIG. 15 is a schematic diagram of a terminal equipment of the embodiment of the ninth aspect. As shown in FIG. 15, a terminal equipment 1500 may include a processor 1510 and a memory 1520, the memory 1520 storing data and programs and being coupled to the processor 1510. It should be noted that this figure is illustrative only, and other types of structures may also be used, so as to supplement or replace this structure and achieve a telecommunications function or other functions. For example, the terminal equipment 1500 may be a reduced capability UE.

For example, the processor 1510 may be configured to execute a program to carry out the methods as described in the embodiments of the first, third and sixth aspects.

As shown in FIG. 15, the terminal equipment 1500 may further include a communication module 1530, an input unit 1540, a display 1550, and a power supply 1560, wherein functions of the above components are similar to those in the prior art, which shall not be described herein any further. It should be noted that the terminal equipment 1500 does not necessarily include all the parts shown in FIG. 15, and the above components are not necessary. Furthermore, the terminal equipment 1500 may include parts not shown in FIG. 15, and the prior art may be referred to.

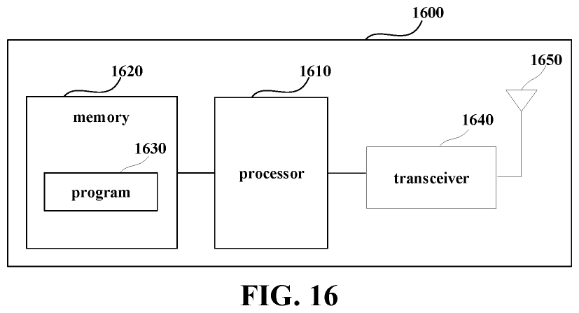

FIG. 16 is a schematic diagram of a network device of the embodiment of the ninth aspect. As shown in FIG. 16, a network device 1600 may include a processor 1610 (such as a central processing unit (CPU)) and a memory 1620, the memory 1620 being coupled to the processor 1610. Wherein, the memory 1620 may store various data, and furthermore, it may store a program 1630 for information processing, and execute the program 1630 under control of the processor 1610.

For example, the processor 1610 may be configured to execute a program to carry out the method as described in the embodiment of the second or the fourth or the fifth aspect.

Furthermore, as shown in FIG. 16, the network device 1600 may include a transceiver 1640, and an antenna 1650, etc. Wherein, functions of the above components are similar to those in the prior art, and shall not be described herein any further. It should be noted that the network device 1600 does not necessarily include all the parts shown in FIG. 16, and furthermore, the network device 1600 may include parts not shown in FIG. 16, and the prior art may be referred to.

An embodiment of this disclosure provides a computer readable program, which, when executed in a terminal equipment, causes the terminal equipment to carry out the methods as described in the embodiments of the first, third and sixth aspects.

An embodiment of this disclosure provides a computer storage medium, including a computer readable program, which causes a terminal equipment to carry out the methods as described in the embodiments of the first, third and sixth aspects.

An embodiment of this disclosure provides a computer readable program, which, when executed in a network device, causes the network device to carry out the methods as described in the embodiments of the second, fourth and fifth aspects.

An embodiment of this disclosure provides a computer storage medium, including a computer readable program, which causes a network device to carry out the methods as described in the embodiments of the second, fourth and fifth aspects.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

As to implementations containing the above embodiments, following supplements are further disclosed.

### (First Group of Supplements)

1. A method for transceiving a signal, applicable to a reduced capability UE (Redcap UE), the method including:
obtaining configuration of a first initial downlink BWP by the Redcap UE, the first initial downlink BWP being an initial downlink BWP that is separately configured or defined for the Redcap UE; and
receiving a signal by the Redcap UE by using the first initial downlink BWP before random access is completed.

2. The method according to supplement 1, wherein,
the Redcap UE receives the signal by using the first initial downlink BWP before an initial access procedure or a random access procedure.

3. The method according to supplement 2, wherein,
the Redcap UE camps on the first initial downlink BWP before the initial access procedure or before the random access procedure.

4. The method according to supplement 1, wherein,
the Redcap UE receives the signal by using the first initial downlink BWP during the initial access procedure or the random access procedure.

5. The method according to supplement 2 or supplement 4, wherein,
the Redcap UE receives the signal by using the first initial downlink BWP upon reception of the configuration of the first initial downlink BWP or after receiving the configuration of the first initial downlink BWP.

6. The method according to supplement 4, wherein,
the Redcap UE receives the signal by using the first initial downlink BWP during or after an initialization procedure of the random access procedure.

7. The method according to supplement 6, wherein,
the Redcap UE receives the signal by using the first initial downlink BWP when the first initial uplink BWP is used,
wherein the first initial uplink BWP is an initial uplink BWP separately configured or defined for the Redcap UE.

8. The method according to supplement 6, wherein,
the first initial downlink BWP of the Redcap UE has a predetermined identifier (BWP-id).

9. The method according to supplement 6, wherein,
the first initial downlink BWP of the Redcap UE corresponds to a first initial uplink BWP, wherein the first initial uplink BWP is an initial uplink BWP separately configured or defined for the Redcap UE.

10. The method according to any one of supplements 5-10, wherein the method further includes:
receiving an additional SSB by the Redcap UE by using the first initial downlink BWP.

11. The method according to supplement 4, wherein,
the Redcap UE receives the signal by using the first initial downlink BWP during or after a random access resource selection procedure.

12. The method according to supplement 11, wherein,
in the random access resource selection procedure, after the Redcap UE selects an SSB from SSBs defined by a cell, it receives the signal by using the first initial downlink BWP.

13. The method according to supplement 4, wherein,
the Redcap UE receives the signal by using the first initial downlink BWP before receiving a random access response or upon reception of a random access response.

14. The method according to supplement 13, wherein,
the before receiving the random access response includes:
after transmitting a random access message 1 (Msg1, preamble) or a random access message A (preamble+PUSCH),
and the upon reception of a random access response includes:
in starting a random access response window (ra-ResponseWindow).

15. The method according to any one of supplements 5-14, wherein,
the random access message 1 (Msg1, preamble) or the random access message A (preamble+PUSCH) indicates a type of the Redcap UE.

16. The method according to supplement 4, wherein,
when a random access message 3 (Msg3) is transmitted or after a random access message 3 (Msg3) is transmitted, the signal is received by using the first initial downlink BWP.

17. The method according to supplement 16, wherein,
the random access message 1 (Msg1, preamble), or the random access message A (preamble+PUSCH) or the random access message 3 indicates a type of the Redcap UE.

18. The method according to any one of supplements 1-17, wherein,
the first initial downlink BWP partially overlaps or does not overlap with a control resource set 0 (CORESET #0).

19. The method according to any one of supplements 1-18, wherein,
when the Redcap UE is in an idle state or an inactive state or before a random access procedure of radio resource control (RRC) connection reestablishment, the Redcap UE operates in a bandwidth, the bandwidth is one of at least one candidate bandwidth.

20. The method according to Supplement 19, wherein,
the at least one candidate bandwidth includes:
a control resource set 0 (CORESET #0);
an initial downlink BWP to which a non-Redcap UE corresponds; and
the first initial downlink BWP or a control resource set (CORESET) in the first initial downlink BWP used for receiving system information and/or paging and/or a random access response.

21. The method according to supplement 20, wherein,
when the Redcap UE operates in the first initial downlink BWP or the control resource set (CORESET) in the first initial downlink BWP used for receiving system information and/or paging, the method further includes:
obtaining a master information block (MIB) by the Redcap UE;
obtaining a system information block 1 (SIB1); and
switching to the first initial downlink BWP in a case of determining that a cell may be selected.

22. The method according to supplement 20, wherein,
when the Redcap UE is in an idle state or an inactive state or before a random access procedure of radio resource control (RRC) connection reestablishment,
the Redcap UE determines the one bandwidth by using the one bandwidth in the at least one candidate bandwidth or according to indication information of a network device.

23. The method according to supplement 22, wherein,
the indication information is transmitted via the following information or messages:
system information, an RRC release/RRC release with suspend indication message, an RRC reject message or an RRC reconfiguration message.

### (Second Group of Supplements)

1. A method for transceiving a signal, applicable to a network device, the method including:
transmitting configuration of a first initial downlink BWP to a Redcap UE, the first initial downlink BWP being an initial downlink BWP that is separately configured or defined for the Redcap UE; and
transmitting a signal to the Redcap UE by using the first initial downlink BWP before random access of the Redcap UE is completed.

2. The method according to supplement 1, wherein,
the configuration of the first initial downlink BWP transmitted to the Redcap UE includes: configuration of at least one control resource set (CORESET) and/or configuration of at least one common search space (CSS).

3. The method according to supplement 2, wherein,
the control resource set (CORESET) and/or the common search space (CSS) is/are used for the Redcap UE upon reception of system information and/or paging and/or a random access response.

4. The method according to supplement 1, wherein,
the configuration of the first initial downlink BWP is transmitted to the Redcap UE via the system information or RRC dedicated signaling.

5. The method according to supplement 1, wherein,
the signal is transmitted by using the first initial downlink BWP before an initial access procedure or a random access procedure of the Redcap UE.

6. The method according to supplement 1, wherein,
the signal is transmitted by using the first initial downlink BWP during an initial access procedure or a random access procedure of the Redcap UE.

7. The method according to supplement 6, wherein,
during or after transmitting the configuration of the first initial downlink BWP to the Redcap UE, the signal is transmitted by using the first initial downlink BWP.

8. The method according to supplement 6, wherein,
during or after an initialization procedure of the random access procedure of the Redcap UE, the signal is transmitted by using the first initial downlink BWP.

9. The method according to supplement 8, wherein,
when the first initial uplink BWP of the Redcap UE is used, the signal is transmitted by using the first initial downlink BWP,
wherein the first initial uplink BWP is an initial uplink BWP separately configured or defined for the Redcap UE.

10. The method according to supplement 8, wherein,
the first initial downlink BWP of the Redcap UE has a predetermined identifier (BWP-id).

11. The method according to supplement 8, wherein,
the first initial downlink BWP of the Redcap UE corresponds to a first initial uplink BWP,
wherein the first initial uplink BWP is an initial uplink BWP separately configured or defined for the Redcap UE.

12. The method according to any one of supplements 7-11, wherein the method further includes:
an additional SSB is transmitted to the Redcap UE by using the first initial downlink BWP.

13. The method according to supplement 6, wherein,
during or after a random access resource selection procedure of the Redcap UE, the signal is transmitted by using the first initial downlink BWP.

14. The method according to supplement 13, wherein,
in the random access resource selection procedure, after the Redcap UE selects an SSB from SSBs defined by a cell, it transmits the signal by using the first initial downlink BWP.

15. The method according to supplement 6, wherein,
the signal is transmitted by using the first initial downlink BWP before transmitting a random access response or in transmitting a random access response to the Redcap UE.

16. The method according to supplement 15, wherein,
the before transmitting the random access response includes:
after receiving a random access message 1 (Msg1, preamble) or a random access message A (preamble+PUSCH), and the in transmitting a random access response includes:
in starting a random access response window (ra-ResponseWindow) by the Redcap UE.

17. The method according to any one of supplements 7-16, wherein,
the random access message 1 (Msg1, preamble) or random access message A (preamble+PUSCH) indicates a type of the Redcap UE.

18. The method according to supplement 6, wherein,
upon reception of the random access message 3 (Msg3) or after receiving the random access message 3 (Msg3), the signal is transmitted by using the first initial downlink BWP.

19. The method according to supplement 18, wherein,
the random access message 1 (Msg1, preamble), or the random access message A (preamble+PUSCH) or the random access message 3 indicates a type of the Redcap UE.

20. The method according to any one of supplements 1-19, wherein the method further includes:
indicating that when the Redcap UE is in an idle state or an inactive state or before a random access procedure of radio resource control (RRC) connection reestablishment, the Redcap UE operates in a bandwidth, the bandwidth is one of at least one candidate bandwidth.

21. The method according to supplement 20, wherein,
the at least one candidate bandwidth includes:
a control resource set 0 (CORESET #0);
an initial downlink BWP to which a non-Redcap UE corresponds; and
the first initial downlink BWP or a control resource set (CORESET) in the first initial downlink BWP used for receiving system information and/or paging and/or a random access response.

22. The method according to supplement 20, wherein,
the indication information is transmitted via the following information or messages:
system information, a radio resource control (RRC) release/RRC release with suspend indication message, an RRC reject message or an RRC reconfiguration message.

### (Third Group of Supplements)

1. A method for transceiving a signal, applicable to a network device, the method including:
transmitting configuration of a first initial downlink BWP to a Redcap UE, the first initial downlink BWP being an initial downlink BWP that is separately configured or defined for the Redcap UE;
receiving a paging message from a core network; and
determining at least one bandwidth used for transmitting a paging message to the Redcap UE.

2. The method according to supplement 1, wherein,
the bandwidth includes:
an initial downlink BWP of a non-Redcap UE, or a control resource set 0 (CORESET #0), or an additional control resource set (additional CORESET) in the initial downlink BWP of a non-Redcap UE.

3. The method according to supplement 1, wherein,
the bandwidth includes:
an initial downlink BWP of a non-Redcap UE, or a control resource set 0 (CORESET #0), or an additional control resource set (additional CORESET) in the initial downlink BWP of a non-Redcap UE; and
an initial downlink BWP separately configured or defined for the Redcap UE or a control resource set (CORESET) separately configured or defined for the Redcap UE.

4. The method according to supplement 3, wherein,
in a case where both the initial downlink BWP of the non-Redcap UE and the initial downlink BWP of the Redcap UE include the control resource set 0 (CORESET #0) or an additional control resource set (CORESET) for paging,
the network device transmits a paging message to the Redcap UE and the non-Redcap UE in the control resource set 0 (CORESET #0) or the additional control resource set (CORESET) used for paging.

5. The method according to supplement 3, wherein,
in a case where at least one of the initial downlink BWP of the non-Redcap UE and the initial downlink BWP of the Redcap UE does not include the control resource set 0 (CORESET #0) or an additional control resource set (CORESET) for paging,
the network device transmits a paging message by using the initial downlink BWP of the non-Redcap UE, or the control resource set 0 (CORESET #0) or the additional control resource set (additional CORESET) in the initial downlink BWP of the non-Redcap UE and the initial downlink BWP separately configured or defined for the Redcap UE or the control resource set (CORESET) separately configured or defined for the Redcap UE.

6. The method according to supplement 1, wherein,
the bandwidth includes:
an initial downlink BWP separately configured or defined for the Redcap UE, or a control resource set (CORESET) separately configured or defined for the Redcap UE.

7. The method according to supplement 6, wherein the method further includes:
transmitting a paging message by the network device by using the initial downlink BWP separately configured or defined for the Redcap UE, or the control resource set (CORESET) separately configured or defined for the Redcap UE.

8. The method according to supplement 7, wherein the method further includes:
receiving an indication from a core network, the indication being used to indicate whether the paging message is a paging message used for the Redcap UE.

9. The method according to supplement 8, wherein,
reception times of a paging message for paging the Redcap UE and a paging message for paging the non-Redcap UE are different, or structures or IEs of the paging messages are different.

10. The method according to supplement 8, wherein,
the network device includes a centralized unit (CU) and a distributed unit (DU), the CU transmitting the indication to the DU via an F1 interface message.

### (Fourth Group of Supplements)

1. A method for transceiving a signal, applicable to a reduced capability UE (Redcap UE), the method including:
obtaining configuration of a first initial downlink BWP by the Redcap UE, the first initial downlink BWP being an initial downlink BWP that is separately configured or defined for the Redcap UE; and receiving a paging message from a network device.

2. The method according to supplement 1, wherein,
a bandwidth for receiving the paging message includes:
an initial downlink BWP of a non-Redcap UE, a control resource set 0 (CORESET #0), or an additional control resource set (additional CORESET) in the initial downlink BWP of the non-Redcap UE.

3. The method according to supplement 2, wherein,
the method further includes:
retuning a radio frequency (RF) to the initial downlink BWP or CORESET #0 of the non-Redcap UE or the additional control resource set (additional CORESET) in the initial downlink BWP of the non-Redcap UE by the non-Redcap UE according to corresponding paging occasions (POs), so as to receive the paging message.

4. The method according to supplement 1, wherein,
a bandwidth receiving the paging message includes:
the initial downlink BWP, or the control resource set 0 (CORESET #0), of the non-Redcap UE, or the additional control resource set (additional CORESET) in the initial downlink BWP of the non-Redcap UE; and
an initial downlink BWP separately configured or defined for the Redcap UE or a control resource set (CORESET) separately configured or defined for the Redcap UE.

5. The method according to supplement 1, wherein,
a bandwidth receiving the paging message includes:
an initial downlink BWP separately configured or defined for the Redcap UE, or a control resource set (CORESET) separately configured or defined for the Redcap UE.

1. An apparatus for transceiving a signal, applicable to a reduced capability UE (Redcap UE), the apparatus comprising:
a processor configured to obtain configuration of a first initial downlink BWP, the first initial downlink BWP being an initial downlink BWP that is separately configured for the Redcap UE; and
a receiver configured to receive a signal by using the first initial downlink BWP during random access procedure initialization in an initial access procedure or a random access procedure.

2. The apparatus according to claim 1, wherein,
the receiver receives the signal by using the first initial downlink BWP before the initial access procedure or the random access procedure.

3. The apparatus according to claim 2, wherein,
the receiver receives the signal by using the first initial downlink BWP upon reception of the configuration of the first initial downlink BWP or after receiving the configuration of the first initial downlink BWP.

4. The apparatus according to claim 1, wherein,
the receiver is further configured to receive the signal by using the first initial downlink BWP after selection of a carrier for random access.

5. The apparatus according to claim 1, wherein,
the receiver receives the signal by using the first initial downlink BWP upon reception of the configuration of the first initial downlink BWP or after receiving the configuration of the first initial downlink BWP.

6. The apparatus according to claim 1, wherein,
the receiver receives the signal by using the first initial downlink BWP when a first initial uplink BWP is used,
wherein the first initial uplink BWP is an initial uplink BWP separately configured or defined for the Redcap UE.

7. The apparatus according to claim 3, wherein,
the receiver receives the signal by using the first initial downlink BWP during or after a random access resource selection procedure.

8. The apparatus according to claim 1, wherein,
in the random access resource selection procedure, after the processor selects an SSB from SSBs defined by a cell, the Redcap UE receives the signal by using the first initial downlink BWP.

9. The apparatus according to claim 3, wherein,
the receiver receives the signal by using the first initial downlink BWP before receiving a random access response (RAR) or upon reception of a random access response.

10. The apparatus according to claim 9, wherein,
the receiver receives the RARafter transmitting a random access message 1 (Msg1, preamble) or a random access message A (preamble+PUSCH), or in starting a random access response window (ra-ResponseWindow).

11. The apparatus according to claim 3, wherein,
when a random access message 3 (Msg3) is transmitted or after a random access message 3 (Msg3) is transmitted, the signal is received by using the first initial downlink BWP.

12. The apparatus according to claim 1, wherein,
the receiver receives a random access message 2 and/or a random access message 4 by using the first initial downlink BWP during the initial access procedure, and the first initial downlink BWP partially overlaps or does not overlap with a control resource set 0 (CORESET #0).

13. An apparatus for transceiving a signal, applicable to a network device, the apparatus comprising a transmitter configured to:
transmit configuration of a first initial downlink BWP to a Redcap UE, the first initial downlink BWP being an initial downlink BWP that is separately configured for the Redcap UE; and
transmit a signal to the Redcap UE by using the first initial downlink BWP during random access procedure initialization in an initial access procedure or a random access procedure.

14. The apparatus according to claim 13, wherein,
the configuration of the first initial downlink BWP transmitted to the Redcap UE comprises: configuration of at least one control resource set (CORESET) and/or configuration of at least one common search space (CSS).

15. An apparatus for transceiving a signal, applicable to a reduced capability UE (Redcap UE), the apparatus comprising a processor configured to:
obtain configuration of a first initial downlink BWP, the first initial downlink BWP being an initial downlink BWP that is separately configured or defined for the Redcap UE; and
control to operate in a bandwidth when the Redcap UE is in an idle state or an inactive state or before a random access procedure of radio resource control (RRC) connection reestablishment, the bandwidth being one of at least one candidate bandwidth.

16. The apparatus according to claim 15, wherein,
the at least one candidate bandwidth comprises:
a control resource set 0 (CORESET #0);
an initial downlink BWP to which a non-Redcap UE corresponds; and
the first initial downlink BWP or a control resource set (CORESET), in the first initial downlink BWP, used for receiving system information and/or paging and/or a random access response.

17. The apparatus according to claim 16, wherein,
when the Redcap UE operates in the first initial downlink BWP or the control resource set (CORESET) in the first initial downlink BWP used for receiving system information and/or paging, the apparatus further comprises:
obtaining a master information block (MIB) by the Redcap UE;
obtaining a system information block 1 (SIB1); and
switching to the first initial downlink BWP in a case of determining that a cell may be selected.

18. The apparatus according to claim 15, wherein,
when the Redcap UE is in an idle state or an inactive state or before a random access procedure of radio resource control (RRC) connection reestablishment,
the Redcap UE determines the one bandwidth by using the one bandwidth in the at least one candidate bandwidth or according to indication information of a network device.

19. The apparatus according to claim 18, wherein,
the indication information is transmitted via the following information or messages:
system information, an RRC release/RRC release with suspend indication message, an RRC reject message or an RRC reconfiguration message.
